(19) United States
(12) Patent Application Publication
(10) Pub. No.: US 2024/0295709 A1
(43) Pub. Date: Sep. 5, 2024

(54) Optical Fiber Capillary Tube Power Stripper

(71) Applicant: Fuzhou Photop Optics Co., Ltd., Fuzhou (CN)

(72) Inventors: Li Wu, Fuzhou (CN); Bin Zheng, Fuzhou (CN); Zhongwei Yu, Fuzhou (CN); Zhong Cheng, Fuzhou (CN); Lei Lin, Fuzhou (CN)

(21) Appl. No.: 18/193,673

(22) Filed: Mar. 31, 2023

(30) Foreign Application Priority Data
Mar. 2, 2023 (CN) 202310186626.5

(51) Int. Cl. G02B 6/44

(52) U.S. Cl. CPC G02B 6/4429

(57) ABSTRACT

An optical fiber capillary tube power stripper includes a capillary tube having an elongated body including an outer surface and an inner surface that surrounds an elongated optical fiber. The capillary tube (a) defines one or more spaces or gaps in the elongated body between first and second ends of the capillary tube; or (b) includes one or more lateral openings in the elongated body between first and second ends of the capillary tube; or (c) includes the outer surface defining one or more ridges and one or more valleys or grooves that surround the outer surface of the body between first and second ends of the capillary tube.

### CROSS-REFERENCE TO RELATED APPLICATION

This application claims priority to Chinese Patent Application No. 202310186626.5 filed Mar. 2, 2023, the disclosure of which is hereby incorporated by reference in its entirety.

### BACKGROUND

### 1. Field

This disclosure relates to a power stripper for an optical fiber to suppresses, avoid, remove or eliminate evanescent laser light that exits the cladding or coating of the optical fiber.

### 2. Description of Related Art

Heretofore, optical fiber cladding power strippers generally included an elongated heat sink made of, for example, a block of aluminum or copper that included, in the elongated heat sink, an elongated cylindrical hole, an elongated semi-ellipsoid hole, an elongated V-groove, or an elongated square-groove in which the optical fiber is received. The optical fiber in the hole or groove may be coated with one or more high refractive index adhesives disposed between the optical fiber and a wall of the hole or groove.

In an example, the optical fiber in the hole or groove may include a fiber core surrounded by an inner cladding made of, for example, a low refractive index polymer, and, optionally, an outer cladding or coating made of, for example, Acrylate. The one or more high refractive index adhesives may be disposed in contact between the hole or groove and the inner cladding or, when present, the outer cladding.

In an example, where a single high refractive index adhesive is disposed in contact between the outer cladding of the fiber and a wall of the hole or groove, the refractive index of the single adhesive may be, for example, 1.68. In another example, where three high refractive index adhesives are disposed in contact between the inner cladding (after removal of the outer cladding) and the hole or groove, the optical fiber may be divided into three sections which are coated at intervals with the three adhesives having refractive indices of 1.44, 1.46 and 1.56, respectively. In yet another example, the inner cladding (or outer cladding, if present) may be acid etched, e.g., with HF acid, and the single high refractive index adhesive disposed in contact between the inner (or outer) cladding and a wall of the hole or groove may have a refractive index of, for example, 1.56.

In another example, the inner cladding (or outer cladding, if present) may be acid etched, e.g., with HF acid, in multiple, e.g., two, sections with uneven thickness. In an example, the first section may be, for example, 50 mm long and the etched cladding radius may be, for example, 0.156 mm, and the second section may be, for example, 45 mm long and the etched cladding radius may be, for example, 0.1 mm. The first and second sections may be connected by a 5 mm long intermediate section of the fiber cable where the cladding tapers towards the first and second sections. One or more high refractive index adhesives may be disposed in contact between the first section, the second section and the intermediate section.

A drawback of the foregoing optical fiber cladding power strippers is that the acid etching may damage the surface of the fiber core or it is difficult in use of the foregoing optical fiber cladding power strippers to suppresses, avoid, remove or eliminate the evanescent laser light that exits the cladding of the optical fiber.

### SUMMARY

Disclosed herein are some non-limiting embodiments or examples of thin-walled quartz or graphite capillary tubes, each of which is several centimeters long and have an inner diameter that closely matches an outer diameter of an optical fiber disposed in an opening of the capillary tube. In an example, the optical fiber may have a fiber core, a first, inner cladding surrounding the fiber core and, optionally, a second, outer cladding or coating surrounding the first, inner cladding.

In one example, the capillary tube may be cut or formed into the shape of a spiral- or helical- or coil spring-shape defining a continuous space or gap between adjacent turns of the spring. In another example, the capillary tube may be a solid tube having a continuous spiral- or helical-shaped groove formed in an outer surface of the tube. In another example, the capillary tube may be a continuous tube having one or more openings or holes that extend partially or fully through a side-wall of the capillary tube, wherein each opening or hole may be an elongated oval having an elongated axis positioned at an acute angle with respect to a longitudinal axis of the tube or optical fiber. Each example capillary tube may be cut or formed into its respective shape by a laser, in particular, a femtosecond laser.

In an example, the inner diameter of each example capillary tube may be affixed or joined to an outer diameter of the first or (when present) second cladding of the optical fiber disposed in the opening of the tube by high temperature melting the outer diameter of the cladding to adhere to the inner diameter of the capillary tube, or by gluing the outer diameter of the cladding to adhere to the inner diameter of the capillary tube with an epoxy or UV adhesive having a desired refractive index. In an example, the refractive index of the epoxy or UV adhesive may be the same as the refractive index of the cladding.

In an example, the capillary groove, opening or hole may be coated with metal reflective film, or the groove may be inlaid with reflective metal wire.

Also disclosed herein is an optical fiber capillary tube power stripper that comprises an elongated optical fiber and a capillary tube comprising an elongated body including an outer surface and an inner surface that extend between first and second ends of the capillary tube. The inner surface of the capillary tube surrounds the elongated optical fiber proximate, adjacent or in contact with an exterior surface of the elongated optical fiber and the outer surface of the capillary tube is spaced to a side of the inner surface of the capillary tube opposite the elongated optical fiber. The capillary tube can (a) define one or more spaces or gaps in the elongated body between the first and second ends of the capillary tube; or (b) include one or more openings in the elongated body between the first and second ends of the capillary tube; or (c) include the outer surface defining one or more ridges and one or more valleys or grooves that surround the outer surface of the body between the first and second ends of the capillary tube.

### BRIEF DESCRIPTION OF THE DRAWING(S)

FIG. 1A is side view of an example capillary tube in accordance with the principles of the present disclosure in the form of a spiral- or helical- or coil spring-shape which defines a continuous space or gap between adjacent turns thereof;

FIG. 1B is an end view of the example capillary tube of FIG. 1A;

FIG. 1C is a side view of the example capillary tube of FIG. 1A including received in a cylindrical bore defined by the turns thereof an optical fiber or cable;

FIG. 2A is an end view of an example optical fiber or cable that includes a fiber core that is surrounded by a first or inner cladding which, in-turn, is surrounded by a second or outer cladding or coating;

FIG. 2B is an end view of another example optical fiber or cable that includes a fiber core surrounded only by a first or inner cladding, e.g., after removal of the second or outer cladding or coating shown in FIG. 2A;

FIG. 3A is a side view of an example capillary tube in accordance with the principles of the present disclosure in the form of an elongated cylinder or tube which includes a cylindrical outer surface and a cylindrical inner surface that defines an elongated cylindrical bore of the elongated cylinder or tube and one or more openings in a body of the elongated cylinder or tube that extend partially or fully through said body between the cylindrical inner and outer surfaces of said body;

FIG. 3B is an end view of the example capillary tube of FIG. 3A showing, in phantom, openings that extend fully through the cylindrical inner and outer surfaces of said body;

FIG. 3C is an end view of the example capillary tube of FIG. 3B, wherein a plurality, e.g., two, of elongated partial capillary tubes are joined together with, for example, an adhesive, to form the cylindrical body of the capillary tube;

FIG. 3D is an end view of the example capillary tube of FIG. 3A showing, in phantom, openings that extend partially through the cylindrical inner and outer surfaces of said body;

FIG. 3E is an end view of the example capillary tube of FIG. 3D, wherein a plurality of elongated partial capillary tubes are joined together with, for example, an adhesive, to form the cylindrical body of the capillary tube;

FIG. 3F is a side view of the example capillary tube of FIG. 3A including received in the elongated cylindrical bore of the elongated cylinder or tube an optical fiber or cable;

FIG. 4A is a side view of an example capillary tube in accordance with the principles of the present disclosure in the form of an elongated cylinder or tube which includes an outer surface and a cylindrical inner surface that defines an elongated cylindrical bore of the elongated cylinder or tube, wherein the outer surface defines one or more ridges and one or more valleys or grooves surrounding the outer surface;

FIG. 4B is an end view of the example capillary tube of FIG. 4A;

FIG. 4C is an end view of the example capillary tube of FIG. 4B, wherein a plurality, e.g., two, of elongated partial capillary tubes are joined together with, for example, an adhesive, to form the cylindrical body of the capillary tube; and

FIG. 4D is a side view of the example capillary tube of FIG. 4A including received in the elongated cylindrical bore of the elongated cylinder or tube an optical fiber or cable.

### DESCRIPTION

Various non-limiting examples will now be described with reference to the accompanying figures where like reference numbers correspond to like or functionally equivalent elements.

For purposes of the description hereinafter, terms like “end,” “upper,” “lower,” “right,” “left,” “vertical,” “horizontal,” “top,” “bottom,” “lateral,” “longitudinal,” and derivatives thereof shall relate to the example(s) as oriented in the drawing figures. However, it is to be understood that the example(s) may assume various alternative variations and step sequences, except where expressly specified to the contrary. It is also to be understood that the specific example(s) illustrated in the attached drawings, and described in the following specification, are simply exemplary examples or aspects of this disclosure. Hence, the specific examples or aspects disclosed herein are not to be construed as limiting.

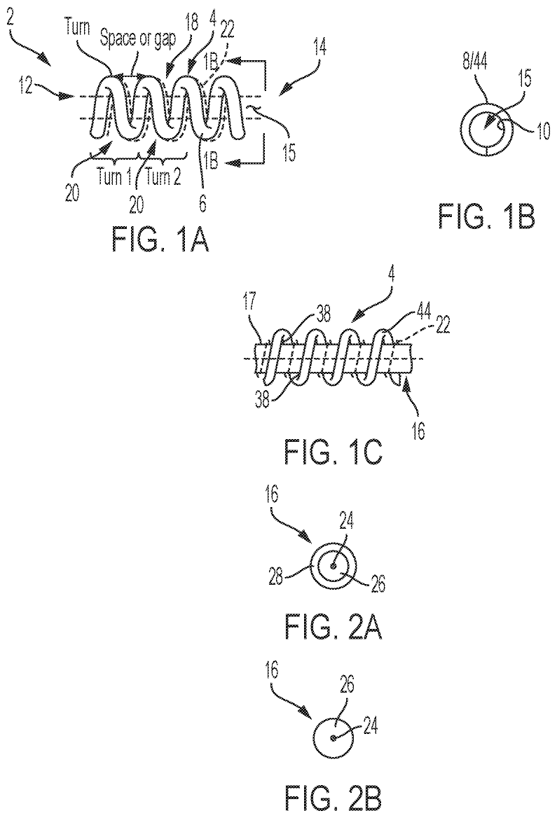

With reference to FIGS. 1A-1C, one non-limiting example optical fiber capillary tube power stripper 2 in accordance with the principles of the present disclosure includes a capillary tube 4 comprising an elongated body 6 including an outer surface or side 8 and an inner surface or side 10 that extend between first and second ends 12 and 14 of the capillary tube 4.

In this example, the capillary tube 4 defines one or more spaces or gaps 18 in the elongated body 6 between the first and second ends 12 and 14 of the capillary tube 4. More specifically, in this example, the elongated body 6 may be helical-shaped, spiral-shaped, or spring-shaped including a number of turns 20 (see e.g., FIG. 1A: Turn 1 and Turn 2) that define a single, continuous helical-shaped, spiral-shaped, or spring-shaped space or gap 18 between pairs of proximate or adjacent turns 20. As shown in phantom in FIG. 1A, the inner surface 10 of the capillary tube 4 defines an elongated opening or bore 15.

In use of the capillary tube 4, the inner surface 10 surrounds an elongated optical fiber 16 proximate, adjacent or in-contact with an exterior surface 17 of the elongated optical fiber 16 and the outer surface 8 of the capillary tube 4 is spaced to a side of the inner surface 10 of the capillary tube 4 opposite the elongated optical fiber 16. In an example, the capillary tube 4 may be disposed on the elongated optical fiber 16 by positioning or sliding the opening or bore 15 of the capillary tube 4 onto the optical fiber 16.

An adhesive 38 may be disposed between the inner surface 10 of the capillary tube 4 and the exterior surface 17 of the optical fiber 16 disposed in the opening or bore 15 of the capillary tube 4. This adhesive 38 may secure the capillary tube 4 and the optical fiber 16 together and/or aid in suppressing, avoiding, removing, or eliminating evanescent laser light that exits the cladding of the optical fiber 16. As an aid in suppressing, avoiding, removing, or eliminating evanescent laser light that exits the cladding of the optical fiber 16, the refractive indices of the adhesive 38 and the core 24 of the optical fiber 16 may match.

A resistance wire or element 22 (shown in phantom) may be disposed in the single, continuous space or gap to aid in suppressing, avoiding, removing, or eliminating evanescent laser light that exits the cladding of the optical fiber 16. In an example, the resistance wire 22 may be a nickel-chromium resistance wire.

FIGS. 2A and 2B show end views of two example optical fibers 16 that may be surrounded by any example capillary tube 4 described herein. In FIG. 2A, the example optical fiber includes a fiber core 24 that is surrounded by a first or inner cladding 26 which, in-turn, is surrounded by a second or outer cladding or coating 28. In FIG. 2B, the example optical fiber includes a fiber core 24 that is surrounded only by the first or inner cladding 26, i.e., the second or outer cladding or coating 28 shown in FIG. 2A is not present or has been removed at least along the length of the optical fiber surrounded by any example capillary tube 4 described herein.

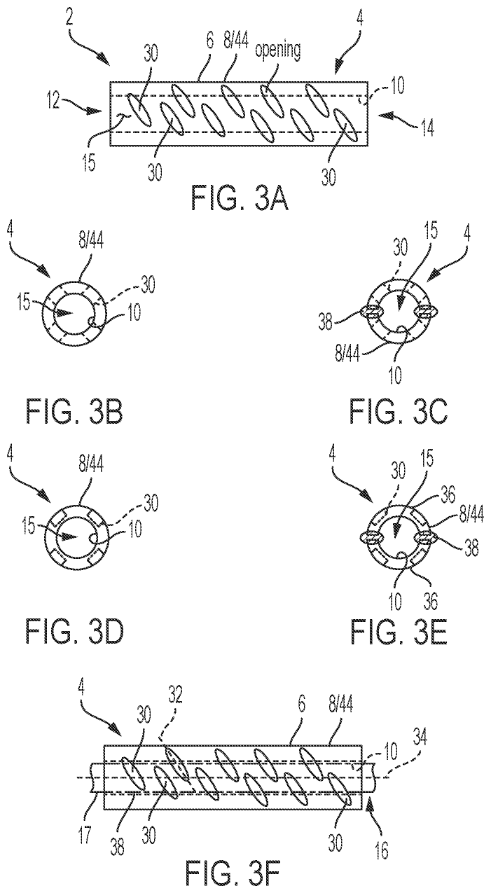

With reference to FIGS. 3A-3F, another non-limiting example optical fiber capillary tube power stripper 2 in accordance with the principles of the present disclosure includes a capillary tube 4 comprising an elongated body 6 including an outer surface or side 8 and an inner surface or side 10 that extend between first and second ends 12 and 14 of the capillary tube 4. In this example, the capillary tube 4 may be in the form of cylinder, tube or pipe with inner surface 10 defining an elongated opening or bore 15.

In use of the capillary tube 4 shown in FIG. 3F, the inner surface 10 surrounds an elongated optical fiber 16 proximate, adjacent or in-contact with an exterior surface 17 of the elongated optical fiber 16 and the outer surface 8 of the capillary tube 4 is spaced to a side of the inner surface 10 of the capillary tube 4 opposite the elongated optical fiber 16. In an example, the capillary tube 4 may be disposed on the elongated optical fiber 16 by positioning or sliding the opening or bore 15 of the capillary tube 4 onto the optical fiber 16.

In this example, the capillary tube 4 includes one or more openings 30 in the elongated body 6 between the first and second ends 12 and 14 of the capillary tube 4. In an example shown in FIGS. 3B and 3C, the one or more openings 30 may extend fully through the elongated body 6 from the outer surface 8 toward the inner surface 10. In another example shown in FIGS. 3D and 3E, the one or more openings 30 may extend partially through the elongated body 6 from the outer surface 8 toward the inner surface 10. In an example, each opening 30 may be oval shaped having an elongated axis 32 positioned at an acute angle with respect to a longitudinal axis 34 of the elongated optical fiber 16. However, opening 30 of other shapes (other than oval shaped) are envisioned.

In the example shown in FIGS. 3B and 3D, capillary tube 4 may be in the form of continuous cylinder, tube or pipe. In another example shown in FIGS. 3C and 3E, capillary tube 4 may be formed by a plurality, e.g., two, of elongated partial capillary tubes 36 joined together, e.g., with an adhesive 38, to form the capillary tube 4.

In any of the examples shown in FIGS. 3A-3F, adhesive 38 may be disposed between the inner surface 10 of the capillary tube 4 and the exterior surface 17 of the optical fiber 16 disposed in the opening or bore 15 of the capillary tube 4. This adhesive 38 may secure the capillary tube 4 and the optical fiber 16 together and/or aid in suppressing, avoiding, removing, or eliminating evanescent laser light that exits the cladding of the optical fiber 16. As an aid in suppressing, avoiding, removing, or eliminating evanescent laser light that exits the cladding of the optical fiber 16, the refractive indices of the adhesive 38 and the core 24 of the optical fiber 16 may match.

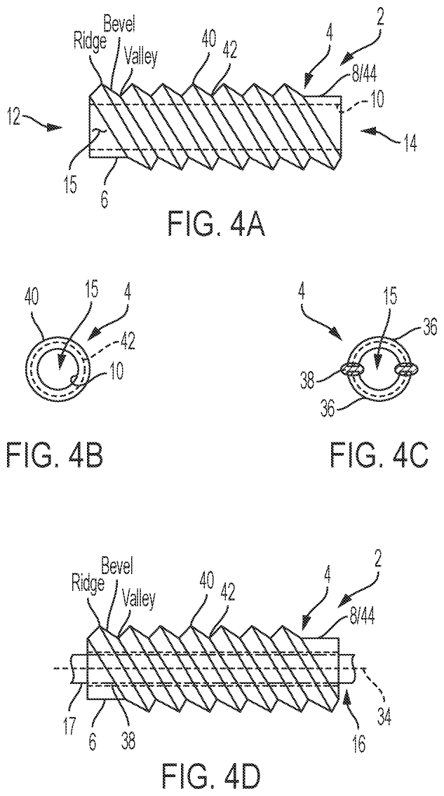

With reference to FIGS. 4A-4D, another non-limiting example optical fiber capillary tube power stripper 2 in accordance with the principles of the present disclosure includes a capillary tube 4 comprising an elongated body 6 including an outer surface or side 8 and an inner surface or side 10 that extend between first and second ends 12 and 14 of the capillary tube 4. In this example, the capillary tube 4 may be in the form of cylinder, tube or pipe with the inner surface 10 defining an elongated opening or bore 15 and with the outer surface 8 defining one or more ridges 40 and one or more valleys or grooves 42 that surround the outer surface 8 of the elongated body 6 between the first and second ends 12 and 14 of the capillary tube 4.

In use of the capillary tube 4 shown in FIG. 4D, the inner surface 10 surrounds an elongated optical fiber 16 proximate, adjacent or in-contact with an exterior surface 17 of the elongated optical fiber 16 and the outer surface 8 of the capillary tube 4 is spaced to a side of the inner surface 10 of the capillary tube 4 opposite the elongated optical fiber 16. In an example, the capillary tube 4 may be disposed on the elongated optical fiber 16 by positioning or sliding the opening or bore 15 of the capillary tube 4 onto the elongated optical fiber 16.

In this example, the outer surface 8 of the capillary tube 4 may have the form of helix-shape, coil-shape, or screw-shape that defines a single continuous helix-shaped, coil-shaped, or screw-shaped ridge 40 and single continuous helix-shaped, coil-shaped, or screw-shaped valley 42. In another example, the outer surface 8 of the capillary tube 4 may include a number of alternating ridges and valleys, i.e., the outer surface 8 of the capillary tube 4 does not have the form of a helix, coil or screw. In this example, the number of alternating ridges and valleys may be circular ridges 40 and circular valleys 42, wherein each ridge 40 and each valley 42 (along the length of the capillary tube 4) is positioned at an acute angle with respect to a longitudinal axis 34 of the optical fiber 16.

In the example shown in FIG. 4B, capillary tube 4 may be in the form of continuous cylinder, tube, or pipe. In another example shown in FIG. 4C, capillary tube 4 may be formed by a plurality, e.g., two, of elongated partial capillary tubes 36 joined together, e.g., with an adhesive 38, to form the capillary tube 4.

In any of the examples shown in FIGS. 4A-4D, adhesive 38 may be disposed between the inner surface 10 of the capillary tube 4 and the exterior surface 17 of the optical fiber 16 disposed in the opening or bore 15 of the capillary tube 4. This adhesive 38 may secure the capillary tube 4 and the optical fiber 16 together and/or aid in suppressing, avoiding, removing, or eliminating evanescent laser light that exits the cladding of the optical fiber 16. As an aid in suppressing, avoiding, removing, or eliminating evanescent laser light that exits the cladding of the optical fiber 16, the refractive indices of the adhesive and the core of the optical fiber may match.

Each example capillary tube 4 in accordance with the principles of the present disclosure may include the elongated body 6 thereof formed of quartz glass or graphite.

Each example capillary tube 4 in accordance with the principles of the present disclosure may be formed from a plurality of partial capillary tubes joined together to form the elongated capillary tube. In one example, the plurality of partial capillary tubes may comprise or consist of two elongated half capillary tubes 36 joined together to form the capillary tube 4.

In an example, adhesive 38 may be used to join the plurality of elongated partial capillary tubes together. In another example, adhesive 38 may, also or alternatively, be disposed between the exterior surface 17 of the optical fiber 16 and the inner surface 10 of the capillary tube 4. In an example, refractive indices of the adhesive 38 and the core 24 of the optical fiber 16 may match.

Finally, each example capillary tube 4 in accordance with the principles of the present disclosure may include a reflective film 44 formed on the elongated body 6 of the capillary tube 4. In an example, the reflective film 44 may be formed by coating the reflective film 44 on the outer surface 8 of the body 6 of the capillary tube 4, the inner surface 10 of the body 6 of the capillary tube 4, or both. In an example, the reflective film 44 is formed at least on the inner surface 10 of the body 6 of the capillary tube 4. In an example, the reflective film 44 is partially or wholly reflective at the wavelength or wavelengths of evanescent laser light that exits or exit the cladding of the optical fiber 16.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. An optical fiber capillary tube power stripper comprising:
an elongated optical fiber; and
a capillary tube comprising an elongated body including an outer surface and an inner surface that extend between first and second ends of the capillary tube, wherein the inner surface of the capillary tube surrounds the elongated optical fiber proximate, adjacent or in contact with an exterior surface of the elongated optical fiber and the outer surface of the capillary tube is spaced to a side of the inner surface of the capillary tube opposite the elongated optical fiber, wherein the capillary tube:
(a) defines one or more spaces or gaps in the elongated body between the first and second ends of the capillary tube; or
(b) includes one or more openings in the elongated body between the first and second ends of the capillary tube; or
(c) includes the outer surface defining one or more ridges and one or more valleys or grooves that surround the outer surface of the body between the first and second ends of the capillary tube.

2. The optical fiber capillary tube power stripper of claim 1, wherein the elongated body is helical-shaped, spiral-shaped, or spring-shaped including a number of turns that define a single, continuous space or gap between pairs of proximate or adjacent turns.

3. The optical fiber capillary tube power stripper of claim 1, further including a resistance wire disposed in the single, continuous space or gap.

4. The optical fiber capillary tube power stripper of claim 3, wherein the resistance wire is a nickel-chromium resistance wire.

5. The optical fiber capillary tube power stripper of claim 1, wherein the one or more openings extend at least partially through the body from the outer surface toward the inner surface.

6. The optical fiber capillary tube power stripper of claim 1, wherein the one or more openings extend fully through the body between the inner and outer surfaces.

7. The optical fiber capillary tube power stripper of claim 6, wherein each opening is oval shaped having an elongated axis positioned at an acute angle with respect to a longitudinal axis of the elongated optical fiber.

8. The optical fiber capillary tube power stripper of claim 1, wherein the outer surface has the form of helix-shape, coil-shape, or screw-shape that defines a single continuous ridge and single continuous valley.

9. The optical fiber capillary tube power stripper of claim 1, wherein the outer surface includes a number of alternating ridges and valleys.

10. The optical fiber capillary tube power stripper of claim 1, wherein each ridge and each valley (along its length) is positioned at an acute angle with respect to a longitudinal axis of the elongated optical fiber.

11. The optical fiber capillary tube power stripper of claim 1, wherein the elongated body is formed of quartz glass.

12. The optical fiber capillary tube power stripper of claim 1, wherein the optical fiber includes an optical fiber core which is surrounded by a cladding which is surrounded by a coating which defines the outer surface of the elongated optical fiber.

13. The optical fiber capillary tube power stripper of claim 1, wherein the optical fiber includes an optical fiber core which is surrounded by a cladding which defines the outer surface of the elongated optical fiber.

14. The optical fiber capillary tube power stripper of claim 1, further including:
an adhesive disposed between the exterior surface of the optical fiber and the inner surface of the elongated capillary tube.

15. The optical fiber capillary tube power stripper of claim 1, wherein the elongated capillary tube is formed from a plurality of partial capillary tubes joined together to form the elongated capillary tube.

16. The optical fiber capillary tube power stripper of claim 15, wherein the plurality of partial capillary tubes consists of two elongated half capillary tubes joined together to form the elongated capillary tube.

17. The optical fiber capillary tube power stripper of claim 15, further including an adhesive:
joining the plurality of elongated partial capillary tubes together; or
disposed between the exterior surface of the optical fiber and the inner surface of the elongated capillary tube; or
both.

18. The optical fiber capillary tube power stripper of claim 17, wherein refractive indices of the adhesive and a core of the optical fiber match.

19. The optical fiber capillary tube power stripper of claim 1, further including a reflective film formed on the body of the capillary tube.

20. The optical fiber capillary tube power stripper of claim 19, wherein the reflective film is formed at least on the inner surface of the body of the capillary tube.
